(19) United States
(12) Patent Application Publication
(10) Pub. No.: US 2005/0035727 A1
(43) Pub. Date: Feb. 17, 2005

(54) Discharge lamp illumination circuit

(76) Inventors: Takao Muramatsu, Shizuoka (JP); Masayasu Ito, Shizuoka (JP); Toshiyuki Tsuchiya, Shizuoka (JP)

Correspondence Address: FISH & RICHARDSON P.C., CITIGROUP CENTER 52ND FLOOR, 153 EAST 53RD STREET, NEW YORK, NY, 10022-4611, US

(21) Appl. No.: 10/915,827

(22) Filed: Aug. 11, 2004

(30) Foreign Application Priority Data
Aug. 13, 2003 (JP) P.2003-292717

(51) Int. Cl. H05B 41/24

(52) U.S. Cl. 315/291; 315/224; 315/276

(57) ABSTRACT

A discharge lamp illumination circuit 1 has a DC-AC conversion circuit 3 for effecting AC conversion upon receipt of a DC input and detection circuits 12, 13 for detecting a voltage and a current of a discharge lamp 10. The circuit controls power output from the DC-AC conversion circuit 3, thereby controlling illumination of the discharge lamp 10. The DC-AC conversion circuit 3 has an AC transformer 7, switching elements 5H, 5L, and a resonance capacitor 8. The resonance capacitor 8 and an inductance component of the AC transformer 7 or an inductance element 9 are brought into series resonance. The detection circuits 12, 13 detect the voltage and current of the discharge lamp 10 through use of a detection winding 7v of the AC transformer 7 and the inductance element 9.

This application claims foreign priority based on Japanese Patent application No. 2003-292717, filed Aug. 13, 2003, the contents of which is incorporated herein by reference in its entirety.

### TECHNICAL FIELD

The present disclosure relates to a technique for inexpensively detecting a voltage and a current of a discharge lamp in a discharge lamp illumination circuit.

### BACKGROUND

A known configuration of a circuit for illuminating a discharge lamp (such as a metal halide lamp) includes a DC power supply circuit having a DC-DC converter, a DC-AC conversion circuit (e.g., an inverter circuit), and a starter circuit. The illumination circuit is provided with a circuit for detecting a voltage applied to the discharge lamp and an electric current flowing through the discharge lamp (see, e.g., Japanese Patent Documents JP-A-7-142182 and JP-A-10-312896).

If the discharge lamp is controlled with constant power when the discharge lamp is in steady illumination, the voltage and current of the discharge lamp must be detected to controll power. For instance, a method for detecting the electric current of the discharge lamp may include detecting a value converted into a voltage by interposing a resistor for detection purpose (e.g., a shunt resistor) between the DC-DC converter and the DC-AC conversion circuit. A method for detecting the voltage of the discharge lamp may include detecting a voltage output from the DC-DC converter through use of a voltage-dividing resistor when the output voltage is essentially equal to the voltage applied to the discharge lamp. In these methods, voltage and current detection signals pertaining to the discharge lamp can be acquired as DC voltage and current.

However, in a configuration in which voltage conversion is effected in two stages (i.e., a DC-DC voltage conversion stage and a DC-AC conversion stage), the configuration becomes unsuitable for reducing the size of a circuit. Therefore, there is adopted a configuration in which an output—whose voltage has been boosted through single-stage voltage conversion in a DC-AC conversion circuit—is supplied to a discharge lamp (see, e.g., Japanese Patent Document JP-A-7-169583). In relation to detection of the voltage and current of the discharge lamp, there are provided a method for directly detecting a voltage appearing at an output terminal of the discharge lamp, and a method for detecting a current through use of a detection resistor and a detection coil, both being connected in series to the discharge lamp.

However, the related-art methods may encounter problems in connection with of miniaturization of a device, cost reduction, detection accuracy, or the like.

For instance, when there is provided a detection circuit for detecting a voltage of an AC output terminal to which the discharge lamp is to be connected, a high-voltage pulse (i.e., a so-called starter pulse) is generated at the time of startup of the discharge lamp, thereby requiring a protective circuit for protecting a constituent element of the detection circuit, which, in turn, is responsible for increased costs or for hindering miniaturization of the device. When voltage conversion is effected through use of a detection element, such as a shunt resistor, for detecting an electric current flowing through the discharge lamp, if the minimum voltage obtained from the detection element at the time of illumination of the discharge lamp is low, deterioration of detection accuracy may be induced. When a rectifying element, such as a diode, is employed in the circuit for detecting an AC waveform, a forward voltage drop is susceptible to the influence of a temperature or the magnitude of a forward current. Therefore, when it is desirable to detect an AC voltage having a small detected voltage amplitude, difficulty may be encountered in performing accurate detection. If the value of the shunt resistor is increased, the amplitude of the detected voltage can be increased. However, there will still remain a problem of an increase in the loss stemming from the resistor or the like.

### SUMMARY

Accordingly, one challenge addressed by the present disclosure is to enable a reduction in size and costs of a discharge lamp illumination circuit having the function of effecting AC conversion and boosting (including boosting of a start-up signal) in a DC-AC conversion circuit and a detection circuit for detecting a voltage and an electric current of a discharge lamp, as well as to ensure the accuracy of detection of the voltage and the electric current.

To address the foregoing problems, the present disclosure discloses a discharge lamp illumination circuit comprising a DC-AC conversion circuit which subjects a DC input to AC conversion upon receipt of the same, and a detection circuit for detecting a voltage of a discharge lamp or an electric current flowing through the discharge lamp, wherein illumination of the discharge lamp is controlled by controlling an output from the DC-AC conversion circuit. The circuit may include the following features.

Specifically, the DC-AC conversion circuit comprises an AC transformer, a plurality of switching elements, and a resonance capacitor. The switching elements are activated to bring into series resonance the resonance capacitor, and inductance components of the AC transformer or an inductance element connected to the resonance capacitor.

The detection circuit detects a voltage or electric current of the discharge lamp through use of windings of the AC transformer or said inductance element.

Moreover, the foregoing configuration can be provided with the following additional features.
An auxiliary winding (which detects the electric current of the discharge lamp by means of the output of the winding)
A winding for detection purpose provided in the AC transformer (which detects the voltage of the discharge lamp by means of the output of the winding)
A capacitor and a rectifying element, which constitute the detection circuit (which converts into a DC signal an AC signal detected from the winding of the AC transformer or the inductance element)
A circuit for suppressing a detected voltage associated with a high voltage developing in the winding of the AC transformer at the time of startup of the discharge lamp.

Therefore, according to the present disclosure, the voltage and current of the discharge lamp can be detected by diverting the winding of the AC transformer and the inductance element constituting the resonance circuit in combination with the resonance capacitor. There is no need to use a resistance element for detecting an electric current.

One or more of the following advantages may be present in some implementations.

The present disclosure may enable easy detection of a voltage and an electric current through use of the winding of the AC transformer and the existing inductance element and, therefore, may be suitable for size-reduction and cost-reduction of a circuit. Moreover, since a resistive element is not required, there is no need to take into consideration a loss of the element or the like, and required detection accuracy can be obtained by ensuring a detection amplitude.

Detection can be performed with a simple configuration through use of the auxiliary winding of the inductance element and the winding of the AC transformer.

An AC signal detected from the AC transformer or the inductance element is converted into a DC signal, whereby processing of the detected signal becomes easy. Moreover, a circuit for suppressing a high voltage associated with generation of a start-up signal of the discharge lamp enables regulation such that the voltage detected at startup does not become excessive.

Other features and advantages may be apparent from the following detailed description, the accompanying drawings and the claims.

### BRIEF DESCRIPTION OF THE DRAWINGS

FIG. 1 is a view showing an example of a basic configuration of the present invention;

FIG. 2 is a circuit diagram showing an example circuit configuration of a current detection circuit according to the present invention;

FIG. 3 is a graph showing a relationship between a lamp current of the discharge lamp and a current detection signal;

FIG. 4 is a circuit diagram showing an example circuit configuration of a current detection circuit according to the present invention;

FIG. 5 is a descriptive view schematically showing the waveform of a lamp voltage; and

FIG. 6 is a graph illustrating a relationship between the lamp voltage of the discharge lamp and the voltage detection signal.

### DETAILED DESCRIPTION

The present disclosure can be applied to illumination circuits of various types of discharge lamps used as an automobile illumination light source, such as a metal halide lamp, and may enable one or more of the following features and advantages.

A circuit for detecting a voltage of a discharge lamp and another circuit for detecting an electric current of the discharge lamp are protected from a start-up pulse voltage generated by a starter circuit at startup of the discharge lamp, and such protection is implemented with a simple circuit configuration (which in turn contributes to miniaturization and cost reduction).

Detection of a voltage is enabled with the same accuracy as that of a method for directly detecting a voltage applied from an AC output terminal to the discharge lamp at the time of illumination of the discharge lamp.

The voltage of the discharge lamp is detected with a sufficiently large detection amplitude and without use of a resistive element (a shunt resistor or the like), thereby diminishing a power loss of a circuit and enabling highly accurate detection.

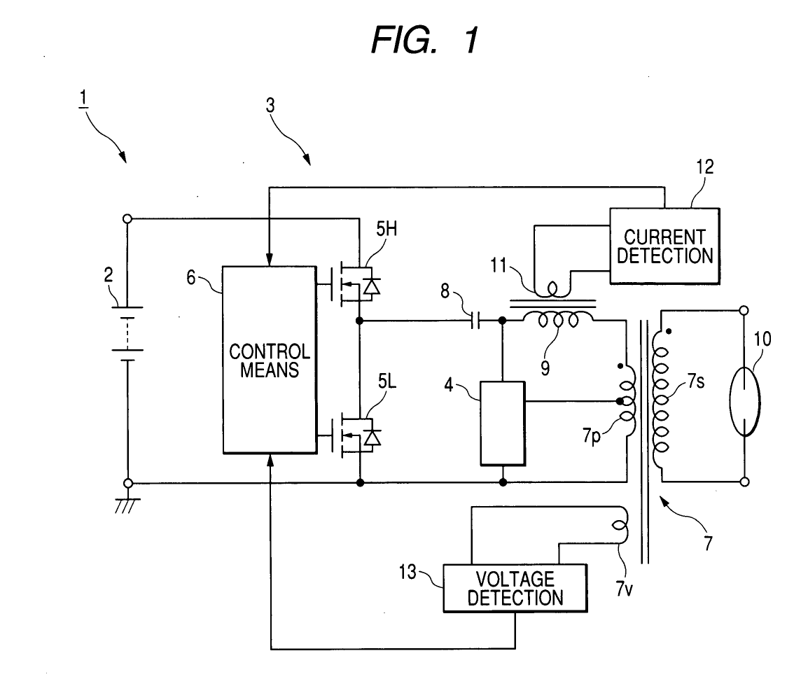

FIG. 1 shows a basic configuration example of the present invention, wherein a discharge lamp illumination circuit 1 includes a DC-AC conversion circuit 3 which receives a power supply from a DC power source 2, and a starter circuit 4.

The DC-AC conversion circuit 3 effects DC-AC conversion and boosting upon receipt of a voltage output directly from a battery or the like. The present embodiment is provided with two switching elements 5H and 5L, and control means 6 which activates the switching elements 5H and 5L to effect switching control. More specifically, one end of the switching element 5H on a higher stage is connected to a power supply terminal, and the other end of the switching element 5H on a lower stage is grounded via the switching element 5L. Further, the switching elements 5H and 5L are alternately activated or deactivated by the control means 6. In the present embodiment, a field-effect transistor (FET) is used for the switching elements 5H and 5L; however, the switching elements 5H and 5L may assume the form of other semiconductor switching elements, such as a bipolar transistor, as required. When an FET is used as in the case of the present embodiment, activation/deactivation is specified in accordance with a drive voltage supplied from the control means 6 to a gate of the FET. Since the FET itself has a parasitic diode, the electric current achieved when the two FETs are in a deactivated state flows by way of the parasitic diode. Moreover, when a bipolar transistor is used, a signal is supplied to the base of the transistor from the control means 6, thereby specifying activation/deactivation of the transistor. When a diode is connected in parallel with that transistor, the electric current achieved when the two transistors are in a deactivated state flows by way of the diode.

The DC-AC conversion circuit 3 has an AC transformer 7 whose primary and secondary circuits are insulated against each other. Further, in the present embodiment, the circuit configuration utilizes a resonance phenomenon between a resonance capacitor 8 and an inductor, or between the resonance capacitor 8 and an inductance component. More specifically, the following two circuit configurations can be enumerated:
(I) a configuration which utilizes resonance between the resonance capacitor 8, an inductance element 9, and the inductance of a primary winding 7p of the AC transformer 7; and
(II) a configuration which utilizes resonance between the resonance capacitor 8, the inductance element 9, and leakage inductance of the AC transformer 7.

The first configuration pattern (I) may incude an addiitonal inductance element 9, such as a resonance coil. For example, one end of the inductance element 9 is connected to one end of the resonance capacitor 8, and the resonance capacitor 8 is connected to a node between the switching elements 5H and 5L; and the other end of the inductance element 9 is further connected to the primary winding 7p of the AC conversion transformer 7. In this case, composite series reactance is used.

In the second configuration (II), composite series reactance, formed from the inductance element 9 and a leakage inductance, can be used.

In any of the above configurations, a discharge lamp 10 connected to a secondary winding 7s of the AC transformer 7 can be subjected to sinusoidal illumination on condition that the operating frequency of the switching elements is specified to a series resonance frequency or higher by utilizing series resonance between the resonance capacitor 8 and an inductive element (e.g., an inductance component or an inductance element), to activate or deactivate the switching elements 5H and 5L alternately. During drive control of the switching elements performed by the control means 6, the elements 5H and 5L must be activated reciprocally so as to prevent the two switching elements from being activated simultaneously (by way of an on-duty control). If a series resonance frequency is denoted as “f”; an electrostatic capacitance of the resonance capacitor 8 is denoted as “Cr”; an inductance of the inductance element 9 is denoted as “Lr”; and a primary-side inductance of the transformer is denoted as “Lp1,” the configuration (I) is employed before illumination of the discharge lamp 10, and there is achieved f=f1=1/(2·π·{square root over (Cr·(Lr+Lp1)))}. Moreover, after illumination of the discharge lamp 10, the configuration (II) is employed, and there is achieved f=f2≈1/(2·π·\sqrt{Cr·Lr}) (f1<f2)

The present invention can be applied without regard to the configuration pattern assumed by the control means 6. For instance, the following configuration pattern or the like is conceivable. Specifically, a control voltage is specified by a circuit for controlling a no-load output voltage before illumination of the discharge lamp, or a circuit for controlling transient input power or input power in a steady state after illumination of the discharge lamp 10. A pulse signal obtained as a result of conversion of the voltage into a frequency through V(voltage)-F(frequency) conversion is shaped, and the shaped pulse signal is transmitted as a control signal to be delivered to the switching elements 5H, 5L.

In order to control the discharge lamp in a stable manner, the operating frequency of the switching elements 5H, 5L achieved after generation of the start-up signal is preferably made higher than that obtained before illumination. Before the discharge lamp is illuminated by application of the start-up signal, the secondary circuit of the AC transformer 7 is opened, whereby the transformer can be deemed as being equivalent to a choke coil. Therefore, the series resonance frequency achieved in this state corresponds to f1, which is lower in frequency than f2 achieved at the time of illumination. At startup, the switching elements are controlled at an operation frequency in the neighborhood of f1. After illumination of the discharge lamp, the switching elements are controlled at an operation frequency located in the neighborhood of the series resonance frequency f2 determined by the electrostatic capacitance of the resonance capacitor 8, the inductance of the inductance element 9, or the inductance and the leakage inductance of the AC transformer 7.

During power control operation, switching is preferably controlled at an operation frequency which is higher than the series resonance frequency. When the operation frequency is brought into coincidence with the series resonance frequency, the maximum power can be extracted. Hence, illumination of the discharge lamp is promoted by supplying the power to the discharge lamp as initial power, thereby enabling quick transition of the discharge lamp to a steady state. When the switching control is performed at an operation frequency which is lower than the series resonance frequency, a composite impedance consisting of the electrostatic capacitance of the resonance capacitor and the inductance enters the capacitive region, whereby the discharge lamp illumination circuit enters an uncontrollable state. For this reason, the operation frequency (switching frequency) is preferably controlled so as to minimize the chance of occurrence of such a state.

The starter circuit 4 is for supplying a start-up signal to the discharge lamp 10. An output from the starter circuit 4 on startup is boosted by the AC transformer 7, and the boosted voltage is supplied to the discharge lamp 10 (the output voltage having undergone AC conversion is superposed on the start-up signal, and thereafter supplied to the discharge lamp).

The present embodiment shows the configuration in which one of the output terminals of the starter circuit 4 is connected to an arbitrary point on the primary winding 7p of the AC transformer 7, and the other output terminal is connected is to one end (a grounded terminal) of the primary winding 7p. However, the circuit configuration is not limited thereto, and there may also be provided a configuration in which the two output terminals of the starter circuit 4 are connected respectively to arbitrary points on the primary winding 7p of the AC transformer 7. To generate a pulse voltage having a peak value required to activate the discharge lamp 10 on the secondary side of the AC transformer 7, a capacitor in the starter circuit 4 should be supplied with as high a voltage as possible so as to recharge the capacitor. In the present embodiment, one input terminal of the starter circuit 4 is connected to a point between the resonance capacitor 8 and the inductance element 9, and the other input terminal is connected to the grounded line, thereby utilizing a resultant resonant voltage. In addition, an input voltage may be supplied to the starter circuit from the secondary side of the AC transformer 7; or an auxiliary winding 11 (to be described below), which constitutes a transformer in combination with the inductance element 9, may supply an input voltage to the starter circuit 4.

The starter circuit 4 may have an arbitrary configuration. For instance, the starter circuit 4 may be formed from a plurality of rectifying elements, capacitors, and switching elements. A self-yielding element, such as a spark gap or a varistor, or a semiconductor element having a control terminal, such as a thyristor, an IGBT (insulated gate bipolar transistor) or an FET, can be used as the switching elements.

The auxiliary winding 11 forming the transformer in combination with the inductance element 9 is for detecting a current corresponding to the current flowing through the discharge lamp 10. An output from the auxiliary winding 11 is supplied to a current detection circuit 12. Specifically, a current flowing in the discharge lamp is detected through use of the inductance element 9 or a portion thereof and the auxiliary winding 11. The detection result is sent to the control means 6, and utilized for controlling power of or discriminating illumination/extinction of the discharge lamp.

The voltage applied to the discharge lamp 10 is detected on the basis of an output from the primary winding 7p of the AC transformer 7, a portion thereof, an output from the secondary winding 7s of the AC transformer 7, a portion thereof, or an output from a detection winding 7v provided on the AC transformer 7 in the present embodiment, an output from the detection winding 7v is supplied to a voltage detection circuit 13, whereby a detected voltage corresponding to a voltage applied to the discharge lamp 10 is obtained by the voltage detection circuit 13. Subsequently, the detected voltage is sent to the control means 6, and utilized for controlling the power of or discriminating illumination/extinction of the discharge lamp or the like.

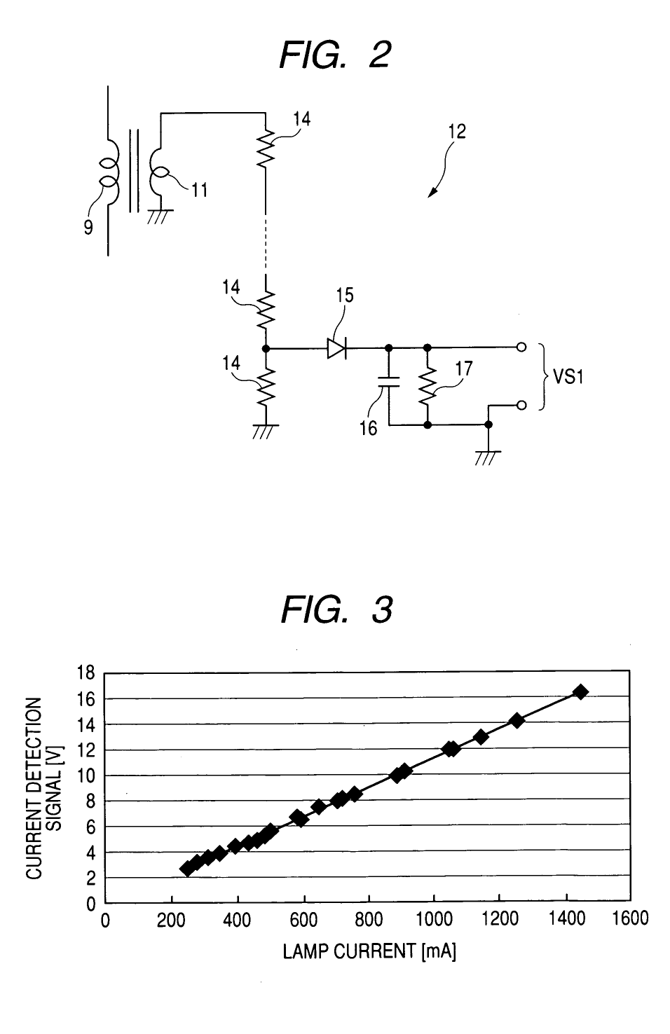

FIG. 2 shows an example circuit configuration of the current detection circuit 12.

A plurality of voltage dividing resistors 14, 14, . . . are connected in series to one end (i.e., a nongrounded terminal) of the auxiliary winding 11. One end of a voltage dividing resistor 14 disposed at a lowest stage is connected to a rectifying element 15, and the other end of the resistor 14 is grounded. In the present embodiment, a diode (e.g., Schottky barrier diode or the like) is used as the rectifying element 15, and the voltage having undergone voltage division is supplied to the anode of the diode, and the cathode of the diode 15 is connected to one of detection output terminals.

One end of a capacitor 16 is connected to the cathode of the rectifying element (diode) 15, and the other end of the same is grounded.

As mentioned above, a detection circuit can be used as the current detection circuit 12. The AC signal detected through use of the inductance element 9 (or a portion thereof) and the auxiliary winding ii is converted into a DC signal (see a detected voltage VS1 shown in FIG. 2), so that there is obtained a signal which can be readily utilized by the control means 6 or the like on a subsequent stage.

A start-up signal (pulse voltage) generated by the starter circuit 4 is subjected to voltage division through use of a plurality of resistor elements, whereby a detected voltage corresponding to a peak voltage of the start-up signal can be suppressed to a level where no problems arise.

Therefore, a circuit for suppressing a high voltage which develops upon startup of the discharge lamp may have a very simple configuration. Under the method for setting the turn ratio of the transformer composed of the inductance element 9 and the auxiliary wiring 11, a situation may arise where sufficient detection accuracy cannot be obtained when the amplitude of the voltage detected at the time of illumination of the discharge lamp becomes excessively low.

The output current (i.e., the secondary current of the AC transformer 7 which is denoted by I2) is proportional to the primary current of the transformer (denoted by I1). Since the current I1 flows into the inductance element 9, I1·(ω·Lr) is detected while the value of the angular frequency ω (corresponding to the operation frequency of the switching element) is taken as being known, whereby a lamp voltage can be ascertained indirectly.

FIG. 3 illustrates a proportional relationship between a lamp current of the discharge lamp and the voltage level of the current detection signal while the lamp current is taken as the horizontal axis and the voltage level is taken as the vertical axis. When the slope of the graph is determined to compute a dispersion and a standard deviation, the resultant dispersion and the resultant standard deviation are ascertained to fall within an error range of 3% or less. In order to enhance the detection accuracy further, a temperature compensation circuit or a correction circuit compatible with a change in the frequency [=ω/(2·π)] preferably is provided for reducing errors.

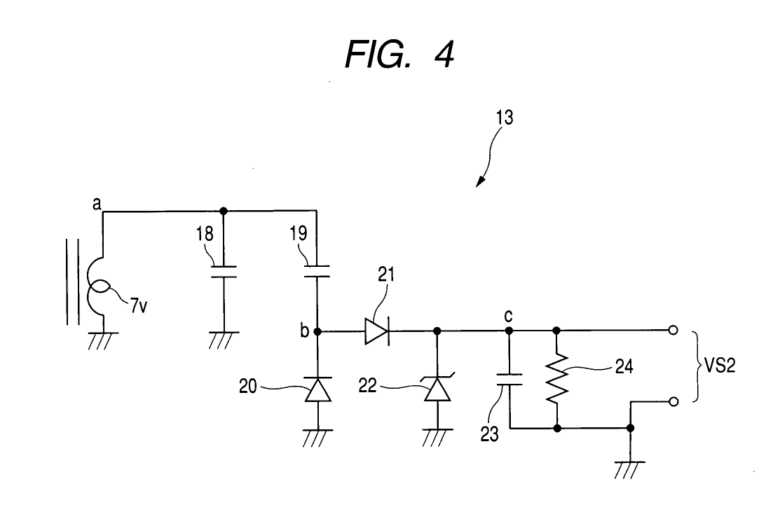

FIG. 4 shows an example of the configuration of the voltage detection circuit 13. The detection circuit 13 includes a rectifying element and a capacitor.

The nongrounded terminal of the detection winding 7v (see point “a” in FIG. 4) is connected to one end of a capacitor 18, and the other end of the capacitor 18 is grounded. Further, a capacitor 19 provided in parallel with the capacitor 18 is connected to the cathode of a diode 20 and the anode of a diode 21. The anode of the diode 20 is grounded.

The cathode of the diode 21 for rectifying purpose is connected to one of detection output terminals and to the cathode of a Zener diode 22 and one end of a capacitor 23. The anode of the Zener diode 22 and the other end of the capacitor 23 are grounded.

A resistor 24 is connected in parallel with the capacitor 23, whereby a detected voltage VS2 is obtained.

Elements which can withstand the pulse voltage (defined as V1×(n2/n1) on condition that the number of turns of a winding portion of the primary winding 7p—to which the output terminal of the starter circuit 4 is to be connected—is denoted as “nl,” and that the number of turns of the detection winding 7v is denoted as “n2”) should be used. However, the remaining elements are not required to have such a high withstand voltage.

In the circuit, at start-up of the discharge lamp, a voltage is, applied on the detection winding 7v with a high-voltage pulse being applied thereto. However, the voltage can be detected by means of the capacitors 19 and 23, and the resistor 24. In relation to impedances of the capacitors 19 and 23, the magnitude of the capacitor 23 is approximately one order of magnitude smaller than that of the capacitor 19. In addition, a resistance value of the resistor 24 is set to become sufficiently larger than the impedance of the capacitor 23. A voltage applied to a point “b” (a node between the anode of the diode 21 and the capacitor 19) in FIG. 4 is determined by an impedance ratio between the capacitors 19 and 23.

After the discharge lamp has been illuminated, an electric current flows only in one direction by the action of the diode 21. Accordingly, the capacitor 23 is recharged, and the electric charges are gradually stored in the capacitor, whereupon a voltage across the capacitor 23 (see a point “c” in FIG. 4) increases. When a potential at one end of the detection winding 7v (a potential achieved at the point “a” in FIG. 4) and a terminal potential (a potential achieved at the point “c” in FIG. 4) of the capacitor 23 have become nearly equal to each other, the current does not flow into the capacitor 19. Specifically, the voltage detected under a steady illumination condition of the discharge lamp can be detected without being subjected to voltage division by the capacitors 19 and 23 even when a voltage applied to the detection winding 7v is small. Thereby, the required accuracy can be ensured.

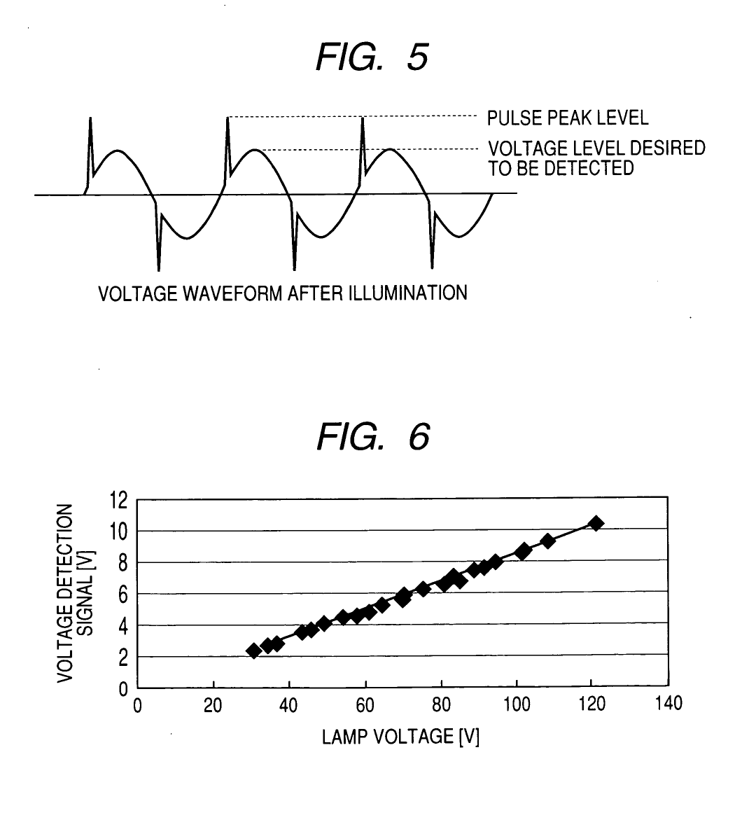

Meanwhile, the capacitor 18 on the first stage is for absorbing a re-striking voltage. When the lamp voltage achieved immediately after illumination of the discharge lamp is low, the peak value of the re-striking voltage has a form resembling a pulse having a narrow width in connection with a voltage waveform schematically shown in, e.g., FIG. 5. Therefore, when the voltage-detection circuit has erroneously detected the peak portion of the voltage, a correct voltage cannot be obtained. For this reason, a configuration which enables accurate detection of a voltage by making the capacitor unresponsive in connection with the re-striking voltage having a high frequency may be adopted.

Moreover, the Zener diode 22 has the function of a clamp element for suppressing a high voltage associated with development of a start-up pulse voltage and plays the role of a limiter for a surge voltage arising at the time of generation of the pulse voltage. The invention is not limited to the Zener diode. In an alternative configuration, when, e.g., a transistor is used, the reference voltage is input to the base of a PNP transistor; the collector of the transistor is grounded; and the emitter of the transistor is connected to a signal line which is desired to be clamped. Alternatively, in another configuration, when an operational amplifier is used, the anode of the diode and an inverted (negative) input terminal are connected together, thereby connecting the cathode of the diode to the output terminal. Further, the reference voltage is input to the non-inverted (positive) input terminal. Thus, a buffer designed specifically for synchronization purpose is constituted, thereby enabling clamping operation such that a signal line connected to the anode of the diode does not exceed the reference voltage.

FIG. 6 illustrates a proportional relationship between the lamp current of the discharge lamp and the level of the voltage detection signal while the lamp current is taken as the horizontal axis and the level is taken as the vertical axis. When the slope of the graph is determined to compute a dispersion and a standard deviation, the resultant dispersion and the resultant standard deviation are ascertained to fall within an error range of 3% or less.

Other implementations are within the scope of the following claims.

1. A discharge lamp illumination circuit comprising:
a DC-AC conversion circuit which subjects a DC input to AC conversion upon receipt of said DC input, and
a detection circuit for detecting a voltage of a discharge lamp or an electric current flowing through the discharge lamp,
wherein illumination of the discharge lamp is controlled by controlling an output from the DC-AC conversion circuit,
wherein the DC-AC conversion circuit comprises an AC transformer, a plurality of switching elements, and a resonance capacitor; and
wherein said switching elements are activated to bring into series resonance the resonance capacitor, and inductance components of said AC transformer or an inductance element connected to said resonance capacitor.

2. The discharge lamp illumination circuit according to claim 1, further comprising an auxiliary winding forming a transformer in combination with said inductance element, wherein said electric current of said discharge lamp is detected from an output of said auxiliary winding.

3. The discharge lamp illumination circuit according to claim 1, wherein the voltage of said discharge lamp is detected from an output of a primary or secondary winding of said AC transformer or a detection winding of said transformer.

4. The discharge lamp illumination circuit according to claim 1 wherein said detection circuit has a capacitor and a rectifying element, and wherein an AC signal detected from the winding of the AC transformer or the inductance element is converted into a DC signal.

5. The discharge lamp illumination circuit according to claim 1 wherein said detection circuit includes a circuit for suppressing a detected voltage associated with a high voltage developing in the winding of the AC transformer at the time of startup of the discharge lamp.
